(19) United States
(12) Patent Application Publication
(10) Pub. No.: US 2019/0225066 A1
(43) Pub. Date: Jul. 25, 2019

(54) Car hood Cover

(71) Applicant: Martyna Bielecka, California, CA (US)

(72) Inventor: Martyna Bielecka, California, CA (US)

(21) Appl. No.: 16/375,309

(22) Filed: Apr. 4, 2019

(51) Int. Cl. B60J 11/06

(52) U.S. Cl. CPC B60J 11/06

(57) ABSTRACT

The present disclosure provides a decorative vehicle cover particularly for a vehicle hood for protection and/or enhancing aesthetics of a vehicle. The decorative vehicle cover includes an exterior surface and an interior surface attached to the vehicle hood. The exterior surface allows for the customization and personalization of graphics to show off love, pride, and/or fandom for a specific sports team, animal, company, and much more. Further, a fastening mechanism for decorative vehicle cover includes a cord attached to the vehicle hood via hook, Velcro, snap fit, spring snap, magnet, cord lock or the like.

### CROSS REFERENCE TO RELATED APPLICATION

This application claims the benefit of U.S. Provisional Application No. 62/636,148 filed on Feb. 27, 2018 which is incorporated by reference herein.

### FIELD OF THE DISCLOSURE

This invention relates to a decorative hood cover for a vehicle, and in particular a hood cover with decorative graphics that can be attached to a vehicle without causing any damage to vehicle paint or other accessories.

### BACKGROUND OF THE DISCLOSURE

Protective and/or decorative covers for covering exterior surfaces of a vehicle and other compartments have been known and/or utilized, with such covers including a pliable cover, made of vinyl material or the like, and various means of securement of the cover on or to the hood are used. These type of vehicle hoods are typically boring and painted with the same color as the vehicle.

Some people may enjoy customizing their vehicles and may be looking for new and exciting customization tools. Sometimes, an individual may wish to advertise for a business on their vehicle and be able to do so without causing damage to his/her vehicle paint. People may be constantly looking for new ways to express themselves. Accordingly, it is an object of the invention to provide an improved vehicle hood cover.

Another object of the invention is to provide a vehicle cover that can be used on a variety of vehicles and offer different levels of protection.

A further object of the present invention is to provide a decorative hood covering designed to show off love, pride, and/or fandom for a specific sports team, animal, company, and much more.

### SUMMARY OF THE DISCLOSURE

In view of the foregoing disadvantages inherent in the prior-art and the needs as mentioned above, the general purpose of the present disclosure is to provide a decorative and/ or protective vehicle cover.

According to an aspect of the present disclosure, a decorative vehicle cover is detachably attached to a vehicle hood. The decorative vehicle cover is made of a sheet of weather-resistant material, which allows the hood cover to stretch tightly around the peripheral edges of the vehicle hood and lie flat across the top surface of the vehicle hood. The decorative vehicle cover is secured to the vehicle hood by a fastening mechanism.

Further, the present invention provides the decorative covering designed to show off love, pride, and/or fandom for a specific sports team, animal, company, and much more. It allows vehicle owners to decorate their car, truck, SUV, etc. in a unique and personalized fashion. The decorative vehicle cover is attached to the vehicle hood via hooks, magnets, snaps, fasteners, cord lock, spring snap mechanism or other connection mechanisms with minimal effort. This eliminates the need to drive a vehicle with a boring, uninspiring hood.

The present invention also offers a way for vehicle owners to advertise their business or display a beautiful, happy, or inspiring photograph, and the vehicle owner is able to do so without causing any damage to vehicle paint.

Further, for the protection point of view the decorative vehicle hood cover can be used on a variety of vehicles, and depending on the vehicle, offer different levels of protection.

The foregoing has outlined, rather broadly, the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be clearly understood, however, that each of the figures is provided for the purpose of illustration and description only and is not intended as a definition of the limits of the present invention.

### BRIEF DESCRIPTION OF THE DRAWINGS

The advantages and features of the present disclosure will become better understood with reference to the following detailed description and claims taken in conjunction with the accompanying drawings, in which:

FIG. 1 shows an illustration of a decorative vehicle cover according to one embodiment of the present disclosure;

FIG. 2 shows an illustration of the decorative vehicle cover on a vehicle hood according to one embodiment of the present disclosure;

FIG. 3 shows an illustration of the decorative vehicle cover mounted on a side mirror of a vehicle according to second embodiment of the present disclosure;

FIG. 4 shows an illustration of a decorative vehicle hood cover according to an exemplary embodiment of the FIG. 1;

FIG. 5 shows an illustration of the decorative vehicle cover on a vehicle hood according to the exemplary embodiment of the FIG. 2; and

FIG. 6 shows an illustration of the decorative vehicle cover mounted on a side mirror of a vehicle according to the exemplary embodiment of the FIG. 3.

### DETAILED DESCRIPTION OF THE DISCLOSURE

Embodiments of the present disclosure will be described more fully hereinafter with reference to the accompanying drawings in which like numerals represent like elements throughout the figures.

The detailed description and the drawings illustrate specific exemplary embodiments by which the disclosure may be practiced. These embodiments are described in detail to enable those skilled in the art to practice the disclosure. It is understood that other embodiments may be utilized, and other changes may be made, without departing from the spirit or scope of the present disclosure. The following detailed description is therefore not to be taken in a limiting sense, and the scope of the present disclosure is defined by the appended claims. Embodiments of the claims may, however, be embodied in many different forms and should not be construed as limited to the embodiments set forth herein.

It is to be further understood that the present disclosure is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present disclosure.

It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. Further, all conjunctions used are to be understood in the most inclusive sense possible.

References to “one embodiment,” “an embodiment,” “example embodiment,” “various embodiments,” etc., may indicate that the embodiment(s) of the disclosure so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

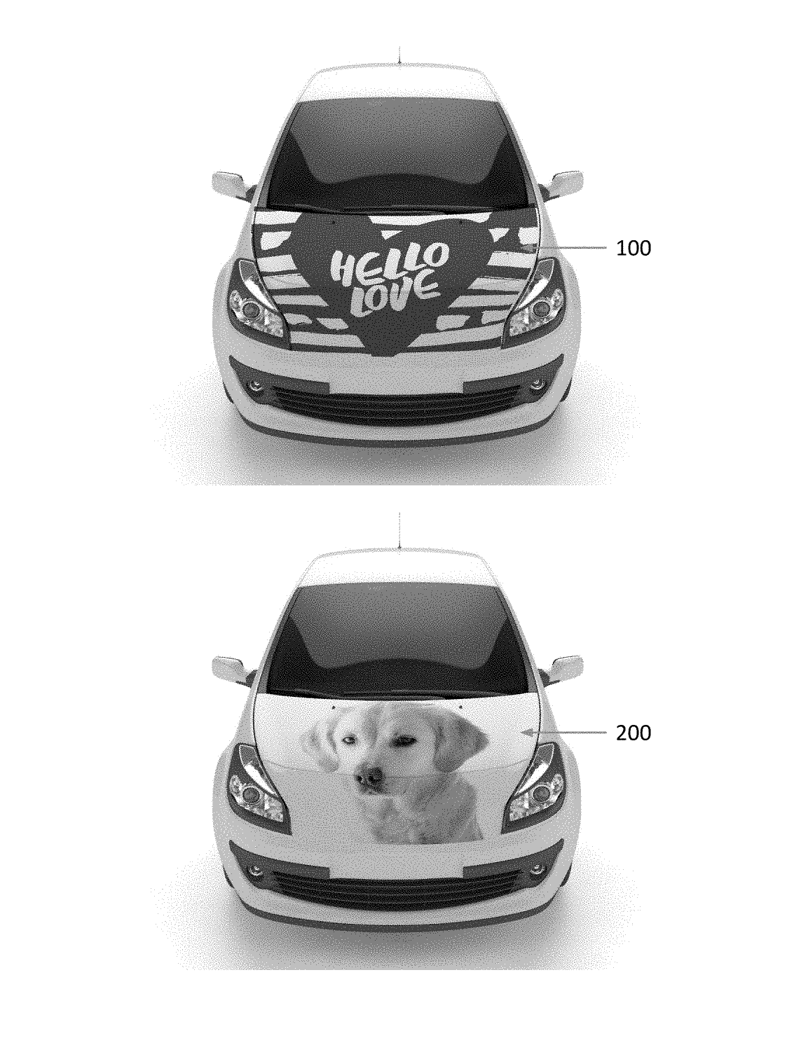

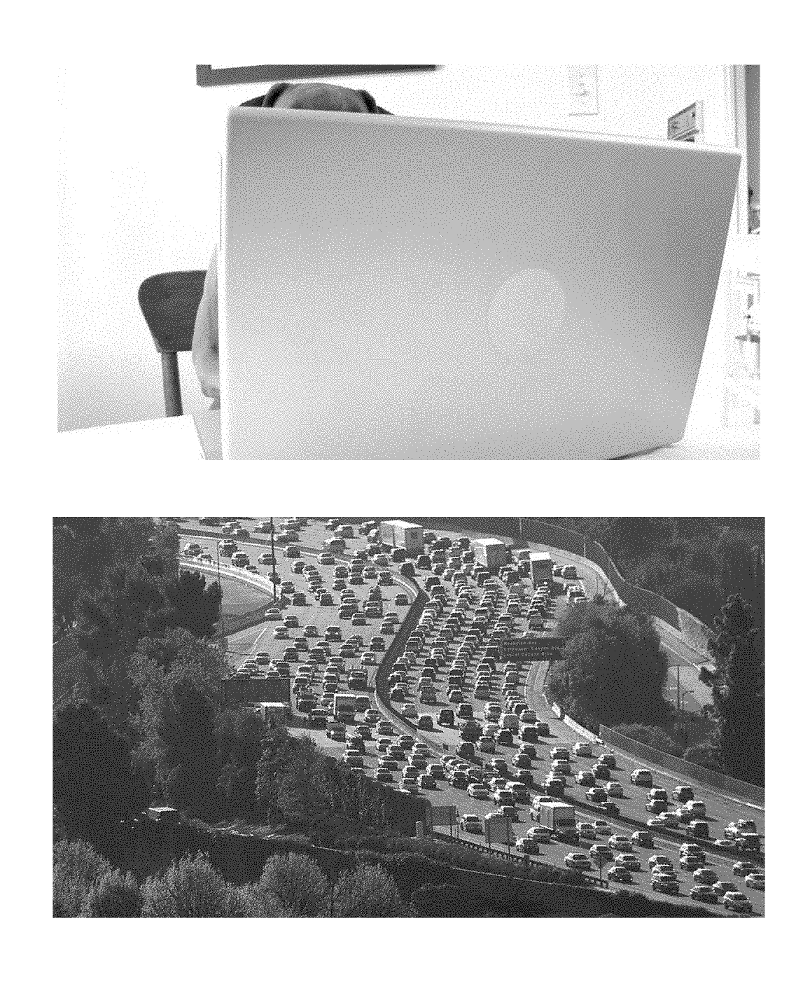

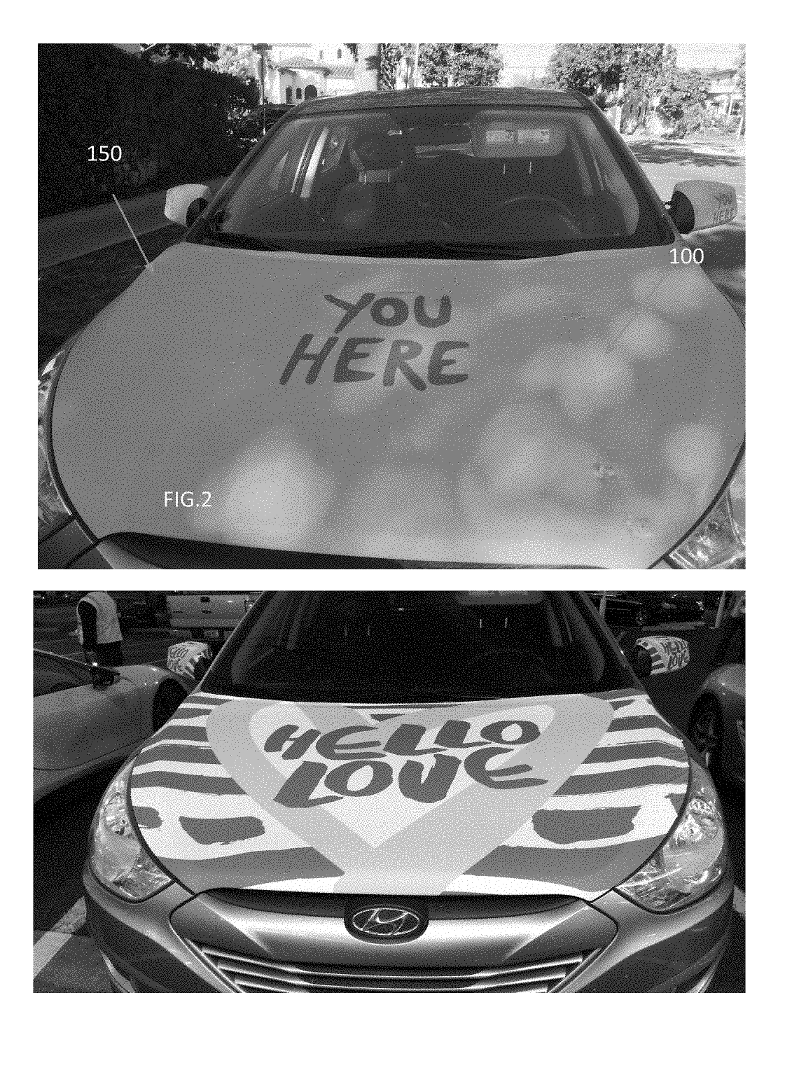

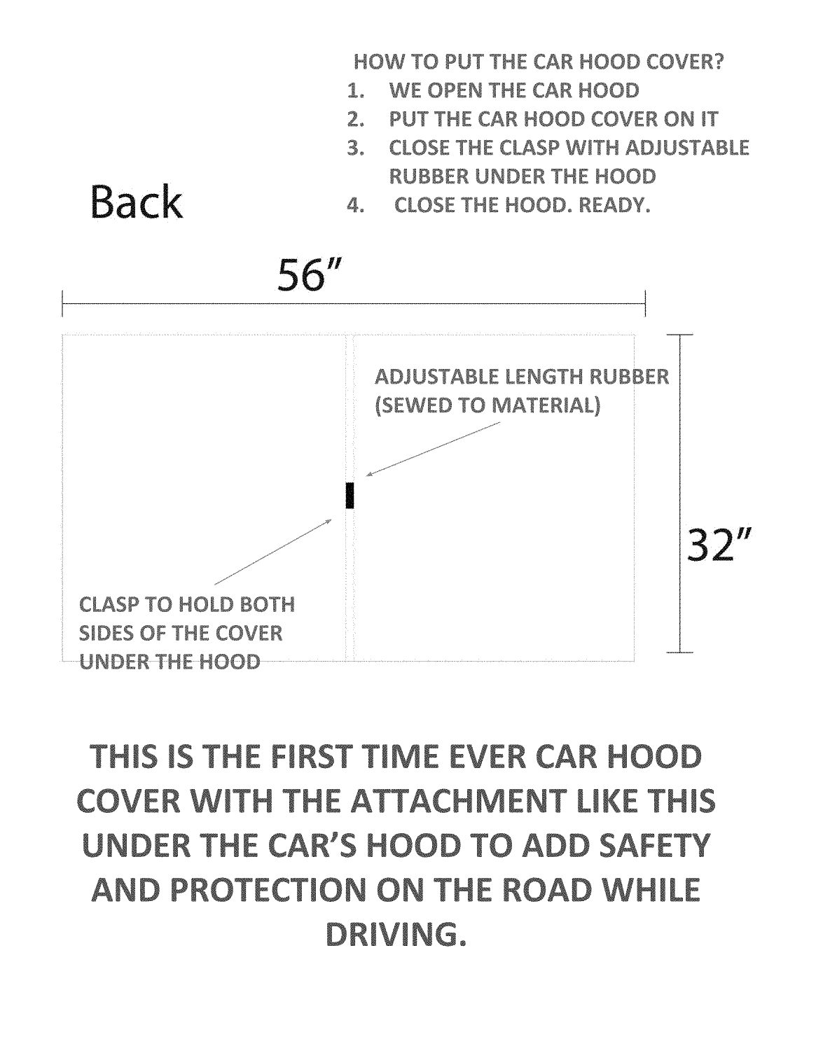

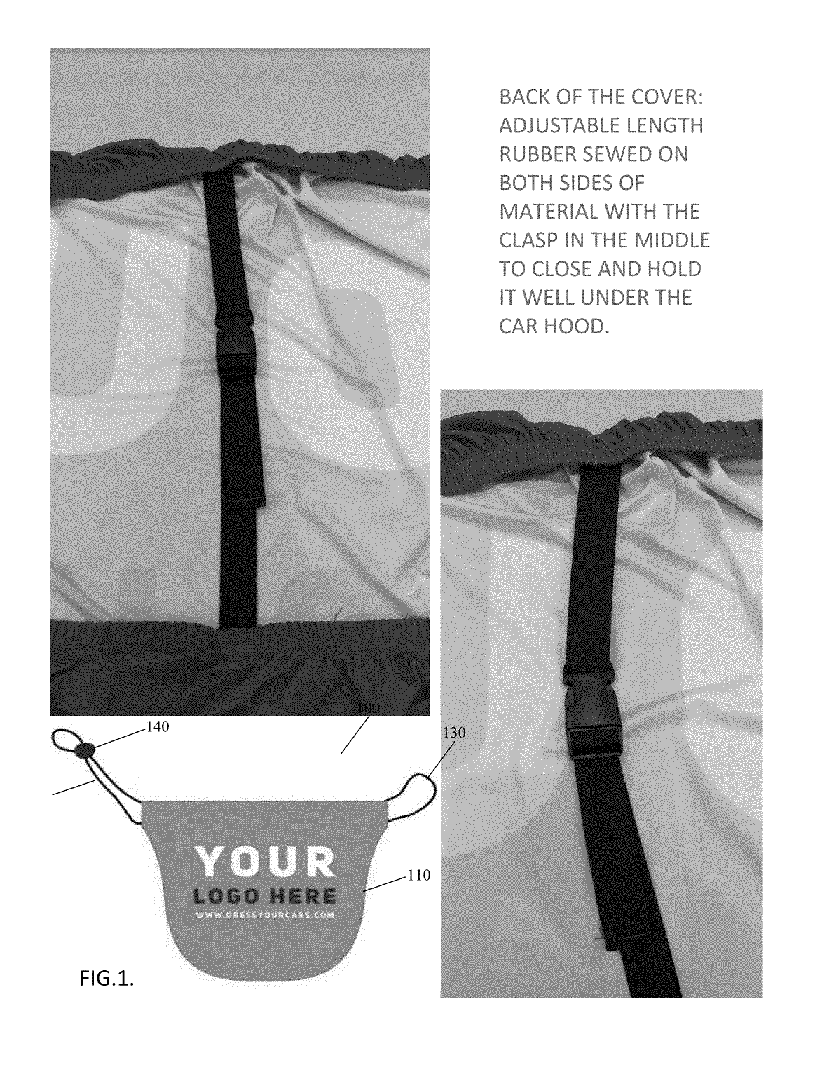

Referring to FIG. 1 and FIG. 2, a decorative vehicle cover 100 is shown according to one embodiment of the present disclosure. The decorative vehicle cover 100 comprises a sheet 110, a first cord 120 with a cord lock 140 and a second cord 130. The decorative vehicle cover 100 is mounted on a car hood 150 as shown in the FIG. 2. The first cord 120 and the second cord 130 are locked with the help of the cord lock 140 mounted on the first cord 120 in a way that it is not visible from the outside. The sheet 110 is made of a weather-resistant material not limited to plastic, rubber, vinyl, etc., which allows the hood cover to stretch tightly around the peripheral edges of the vehicle hood and lie flat across the top surface of the car hood 150. Further, the sheet 110 is having an empty exterior surface marked (“YOUR LOGO HERE” followed by exemplary email address) in the FIG. 1 and FIG. 2.

The sheet 110 can be fastened on the car hood 150 by using different fastening mechanisms not limited to hook, Velcro, snap fit, spring snap, magnet, cord lock or the like.

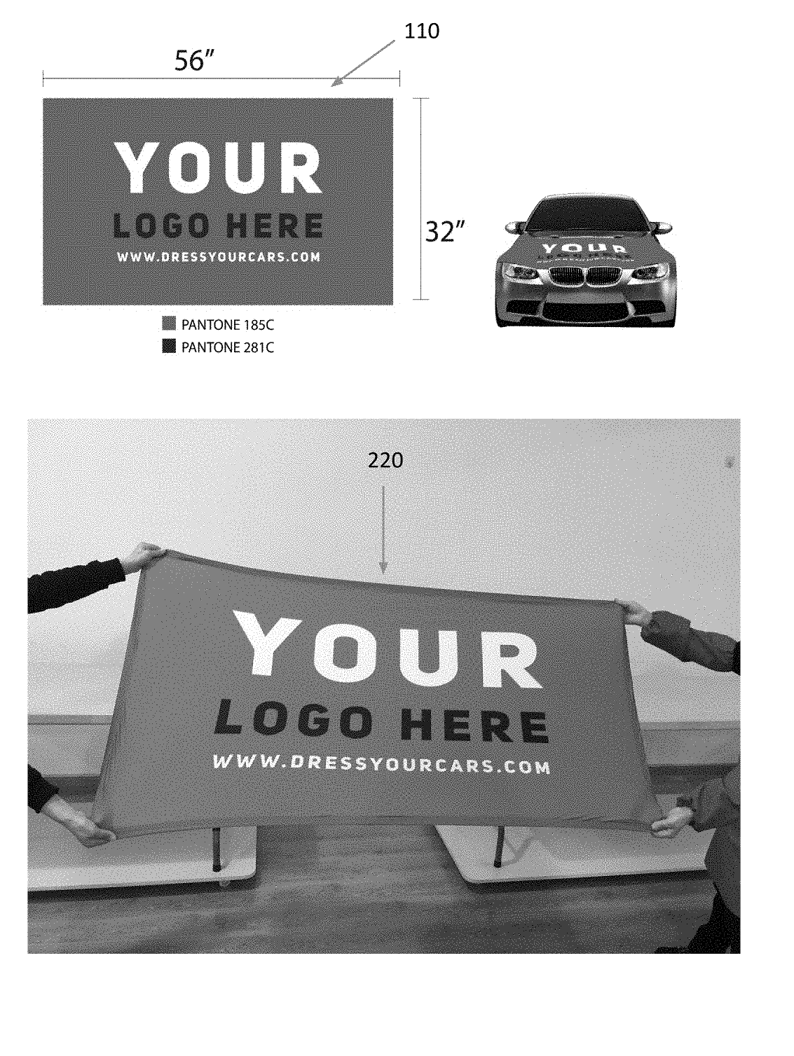

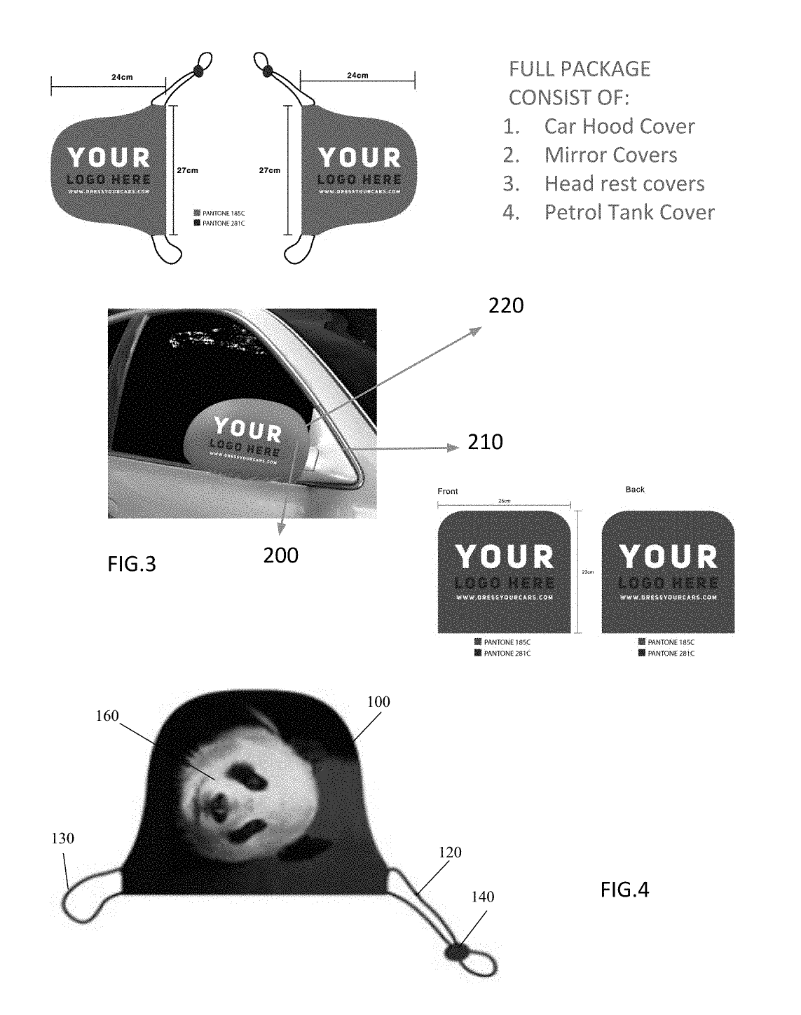

Referring to FIG. 3 shows a decorative vehicle cover 200 according to a second embodiment of the present disclosure. The decorative vehicle cover 200 mounted on the outer casing of a vehicle side mirror 210. The decorative vehicle cover 200 shown in the FIG. 3 is made of same material and have the same features as in the decorative vehicle cover 100 (except the size and shape) shown in the FIG. 1 and FIG. 2 have. Further, a sheet 220 is having an empty exterior surface marked (“YOUR LOGO HERE” followed by exemplary email address) in the FIG. 3.

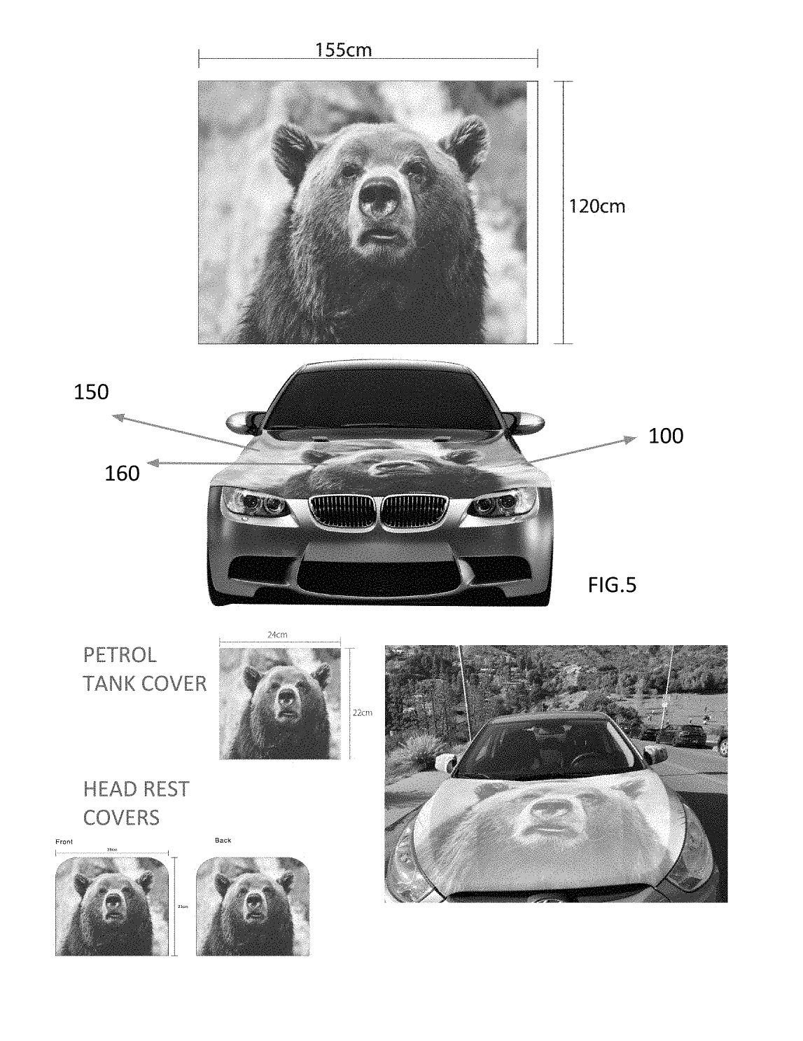

Referring to FIG. 4 and FIG. 5, a decorative vehicle cover 100 is shown according to an exemplary embodiment of the present disclosure of FIG. 1. The decorative vehicle cover comprises a sheet 110, a first cord 120 with a cord lock 140, a second cord 130. The decorative vehicle cover 100 is mounted on a car hood 150 as shown in the FIG. 5. The first cord 120 and the second cord 130 are locked with the help of the cord lock 140 mounted on the first cord 120 in a way that it is not visible from the outside. The sheet 110 is made of a weather-resistant material not limited to plastic, rubber, vinyl, etc., which allows the hood cover to stretch tightly around the peripheral edges of the vehicle hood and lie flat across the top surface of the car hood 150. Further, the empty exterior surface of sheet 110 shown in FIG. 1 and FIG. 2 is now painted with an image of a panda 160 as shown in FIG. 4 and FIG. 5.

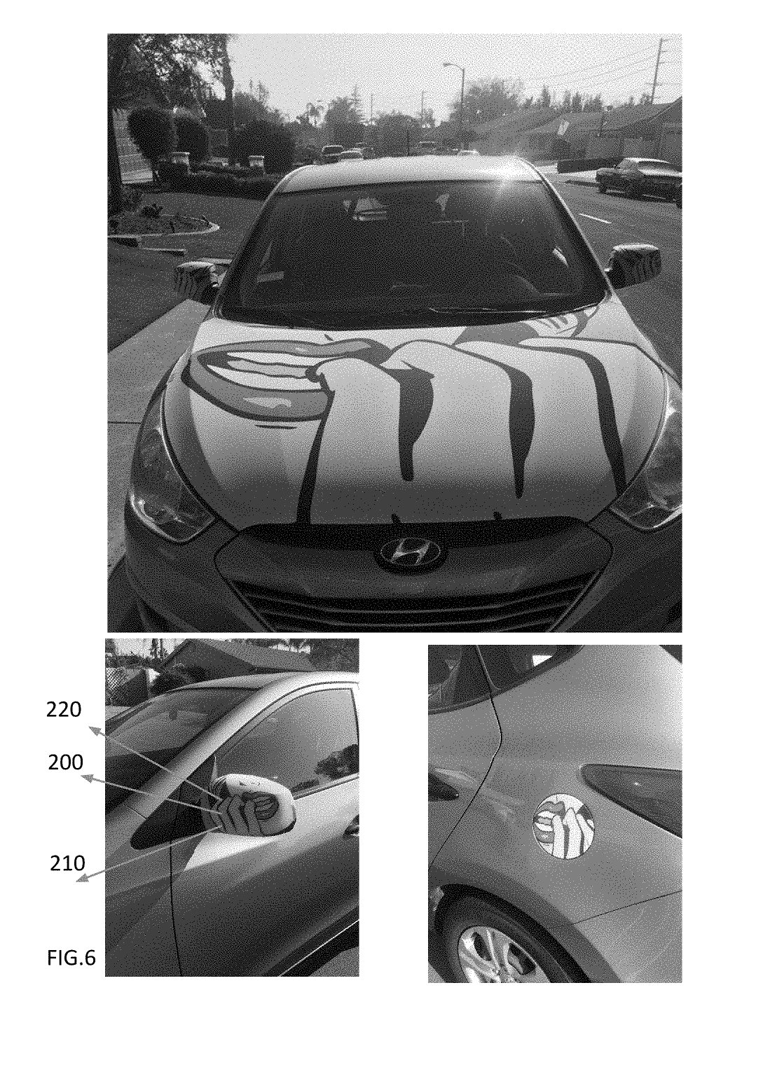

Referring to FIG. 6, shows a decorative vehicle cover 200 according to an exemplary embodiment of the FIG. 3. The decorative vehicle cover 200 mounted on the outer casing of a vehicle side mirror 210. The decorative vehicle cover 200 shown in the FIG. 3 is made of the same material and have the same features as the decorative vehicle cover 100 (except the size and shape) shown in FIG. 4 and FIG. 5 have. Further, the empty exterior surface of a sheet 220 shown in the FIG. 3 is painted with an image of the panda 160 as shown in FIG. 4 and FIG. 5.

According to an alternate embodiment of the present disclosure, the decorative vehicle cover (100 or 200) can also be designed for mirrors and bears the same pattern/picture as the car hood cover.

Further, the sheet 110 is having an empty exterior surface marked (“YOUR LOGO HERE” followed by exemplary email address) in the FIG. 1 and FIG. 2.

According to an alternate embodiment, the user can choose how to customize and decorate the decorative vehicle cover (100 or 200) in order to show pride and fandom for a specific brand, photograph, memory, etc. Further, the decorative vehicle cover (100 or 200) can have decorative designs having customized indicium not limited to a customize graphics, a photograph, favorite sports team logo, business advertisement, and much more without damaging the vehicle paint.

According to yet another embodiment of the present disclosure, the device may be available in numerous sizes, suited to accommodate all user needs and preferences. There is no limit as to what designs can be applied to the cover. Exact size, measurement, construction, and design specifications may vary upon manufacturing.

Best Mode: The user opens the car hood and puts the decorative vehicle cover (100, 200) and stretches it to cover the peripheral edges of the vehicle hood. After stretching it all over the car hood (upper side of the car hood) the user tighten the fasteners (cord lock, snap fit or other fastening mechanisms) towards underside of the car hood and closes the car hood. The decorative vehicle cover (100, 200) is not limited to cover only vehicle hood but also can also be made in different shape and sizes in order to cover a gas tank cover, side mirrors, wheel caps, seat cushion etc.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

Embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Although specific embodiments and certain structural arrangements have been illustrated and described herein, it will be clear to those skilled in the art that various other modifications and embodiments may be made incorporating the spirit and scope of the underlying inventive concepts and that the same is not limited to the particular methods and structure herein shown and described except in so far as determined by the scope of the appended claims.

### LIST OF ELEMENTS

100 and 200—decorative vehicle cover;
110 and 220—sheet;
120—first cord;
130—second cord;
140—cord lock;
150—car hood;
160—panda; and
210—car side mirror.

What is claimed is:

1. A decorative vehicle cover detachably attached to a vehicle hood comprising:
a sheet having an exterior surface and an interior surface;
a decorative graphic is printed on the exterior surface of the sheet; and
a fastening mechanism for fixing the sheet on the vehicle hood,
wherein the decorative vehicle cover is designed to show off love, pride, and/or fandom for a specific sports team, animal, company, and improving aesthetics of a vehicle.

2. The decorative vehicle cover claimed in claim 1, wherein the interior surface is made of soft material causing no harm to vehicle paint.

3. The decorative vehicle cover claimed in claim 1, wherein the decorative graphics is a customized indicium not limited to a customize graphics, a photograph, favorite sports team logo, business advertisement, and much more.

4. The decorative vehicle cover claimed in claim 1, wherein the fastening mechanism includes a cord attached to the vehicle hood via hook, Velcro, snap fit, spring snap, magnet, cord lock or the like.

5. The decorative vehicle cover claimed in claim 1, wherein the decorative vehicle cover may be made of plastic, textile, rubber or any other suitable material.

6. The decorative vehicle cover claimed in claim 1, wherein the decorative vehicle cover is made of durable, robust and weather resistant material.

7. The decorative vehicle hood cover claimed in claim 1, wherein the sheet is also designed for decorating outer casings of vehicle side mirrors, wheel caps, gas tank cover, seat cushions etc.

8. The decorative vehicle cover claimed in claim 1, wherein the decorative vehicle cover can be customized in different shapes and sizes as per requirement of the vehicle.

9. The decorative vehicle cover claimed in claim 1, wherein a user can customize the decorative vehicle cover for advertising business or display a beautiful, happy, or inspiring photograph.

10. The decorative vehicle cover claimed in claim 1, wherein the decorative vehicle cover is protecting the vehicle hood from foreign object damage.
